(19) United States
(12) Patent Application Publication
(10) Pub. No.: US 2010/0151091 A1
(43) Pub. Date: Jun. 17, 2010

(54) BAKED PRODUCT ON A SUPPORT MEMBER

(76) Inventors: Jan Malan Hofmeyr, Rancho Santa Fe, CA (US); Johanna Gertruida Hofmeyr, Rancho Santa Fe, CA (US)

Correspondence Address: SCHWEGMAN, LUNDBERG & WOESSNER, P.A., P.O. BOX 2938, MINNEAPOLIS, MN, 55402, US

(21) Appl. No.: 12/332,379

(22) Filed: Dec. 11, 2008

(51) Int. Cl. A21D 13/00; A21D 6/00; B23P 11/00

(52) U.S. Cl. 426/134; 426/421; 426/549; 29/428; 16/430

(57) ABSTRACT

A method of creating a baked product assembly includes providing a body of dough to be baked. A support member is inserted into the body of the dough prior or during baking of the body of dough. The inserting of the support member includes embedding a first section of the support member within the body of dough such that a second section on the support member protrudes from the portion of the dough.

### TECHNICAL FIELD

An example embodiment pertains generally to a device for handling baked products (e.g., cookies, biscuits, biscotti and rusks) and a method of use and manufacturing thereof. More specifically, an example embodiment relates to a device and method by which a baked product is produced to enable such a baked product to be dunked into coffee, tea, milk or other liquids without the user's hand having to contact the liquid.

### BACKGROUND

The act of dunking (or dipping) a cookie in milk is a popular way many people enjoy eating their cookie today especially amongst the younger demographics. The cookie is soaked in the milk for a period of time to allow for the milk to be absorbed before eaten.

While cookies are a popular sweet used for dunking, there are many other hard baked biscuits including but not limited to biscotti and rusks (South African biscuit), that people can enjoy by dipping or dunking the baked biscuit into a cold or warm liquid substance to absorb the substance's flavor and soften the biscuit.

While dunking a cookie or biscuit is common today, there are many drawbacks. When dunking a cookie or biscuit, most users will use their fingers to hold the cookie when dunking it into a liquid. If the person dunks the cookie or biscuit in a hot liquid such as coffee or tea, the danger exists that the hot liquid may burn their fingers.

There have been several attempts to develop devices that can be used to hold a cookie for the purpose of dunking the cookie into a liquid (milk being the most common liquid). Three examples of such devices are described in (a.) U.S. Pat. No. D0544764 titled “Food Holding Implement,” (b.) U.S. Pat. No. 7,090,269 titled “Culinary Apparatus,” and (c.) US Patent Publication No. 20050109222 titled “Cookie Handling Device.”

The device discussed in U.S. Pat. No. D0544764 was specifically designed for sandwich-type biscuits, where a layer of ‘cream’ or icing is sandwiched between two biscuits. The device then functions like tongs that grabs onto the soft inner layer of the biscuit before dunking the biscuit into milk. A disadvantage of this approach is that the use of the device is limited to these “sandwich-type biscuits.” Another disadvantage is the fact that the biscuit can easily become dislodged from the device when the biscuit absorbs the milk when dunked. Yet another disadvantage is the fact that the device is provided separate from the biscuit and therefore makes it inconvenient to always have the device handy when dunking a biscuit.

The device discussed in U.S. Pat. No. 7,090,269 was designed to address the problem of a biscuit breaking up when dunked into a liquid, and discusses implementing a container like holder at the end of a tong device. The disadvantage of this device is that removing the biscuit from the “container like holder,” after being dunked into a liquid, can easily cause the biscuit to break up and therefore making it difficult and messy to eat. Another disadvantage is the fact that the device is provided separate from the biscuit and therefore makes it inconvenient to always have the device handy when dunking a biscuit.

The device discussed in US Patent Publication No. 20050109222 was specifically designed for sandwich-type biscuits, where a layer of ‘cream’ or icing is sandwiched between two biscuits, but was intended as to improve on both the devices discussed in U.S. Pat. No. D0544764 and device discussed in U.S. Pat. No. 7,090,269. This device allows the user to partially insert the device into the soft inner layer between the two biscuits before dunking the biscuit into a liquid. The disadvantage of this approach is the fact that the use of the device is limited to “sandwich-type biscuits” and strictly relies on the fact that the biscuit has a soft inner layer. Another disadvantage is the fact that the device is provided separately from the biscuit and therefore makes it inconvenient to always have the device handy when dunking a biscuit.

The devices discussed above all have significant disadvantages that make them difficult, and in most cases impossible, to use when dunking any cookie or biscuit other than the sandwich-type biscuit.

### BRIEF DESCRIPTION OF THE DRAWINGS

Various exemplary embodiments are shown and described in reference to the drawings. It will be appreciated that the embodiments shown are illustrative but not limited to the scope of the invention, which is set forth in the claims.

FIG. 1 shows a perspective view of the dunking stick in accordance with one exemplary embodiment.

FIG. 1a shows the perspective view of the dunking stick and outlines the part of the dunking stick that is baked into the cookie or biscuit.

FIG. 1b shows the perspective view of the dunking stick with marketing or branding information in accordance with an exemplary embodiment.

FIG. 1c shows the perspective view of cookies or biscuits in a baking pan with the embedded dunking sticks in accordance with an exemplary embodiment.

FIG. 1d shows an illustration of the dunking stick, in accordance with an exemplary embodiment, being used to dunk a biscuit.

FIG. 2 shows another embodiment of a dunking stick in accordance with an exemplary embodiment.

FIG. 2a shows yet another embodiment of a dunking stick in accordance with an exemplary embodiment.

FIG. 2b shows yet another embodiment of a dunking stick in accordance with an exemplary embodiment.

FIG. 2c shows yet another embodiment of a dunking stick in accordance with an exemplary embodiment.

FIG. 2d shows yet another embodiment of a dunking stick in accordance with an exemplary embodiment.

FIG. 3 shows yet another embodiment of a dunking stick in accordance with an exemplary embodiment.

FIG. 3a shows yet another embodiment of a dunking stick in accordance with an exemplary embodiment.

FIG. 3b shows yet another embodiment of a dunking stick in accordance with an exemplary embodiment.

FIG. 3c shows yet another embodiment of a dunking stick in accordance with an exemplary embodiment.

FIG. 3d shows yet another embodiment of a dunking stick in accordance with an exemplary embodiment.

FIG. 4 shows a flowchart of a method 400 of manufacturing (baking) in accordance with an exemplary embodiment.

FIG. 5 shows a flowchart of a method 500 of a baked product dunking process in accordance with an exemplary embodiment.

FIG. 6 is a photograph of a baking product assembly, according to an exemplary embodiment.

### DETAILED DESCRIPTION

The drawings will now be discussed in reference to the numerals provided thereon so as to enable one skilled in the art to make and use the present invention. It will be appreciated that the drawings and descriptions thereof are for explanatory purposes and are not intended to narrow the scope of the appended claims.

Example embodiments provide improved methods for manufacturing a baked product for a dunking or immersion in a liquid, a baked product for dunking or immersion in a liquid, and method of dipping or dunking or otherwise immersing a baked product (e.g., a baked product) in a liquid.

Example embodiments include a method of manufacturing a baked product assembly, the method including inserting a support member (or other support or ripping device) into the dough prior to or during a baking process. The support member remains inserted into the dough throughout the baking process to become part of the final baked product assembly. The support member is used by consumers to dunk the baked product assembly into a liquid prior to eating the baked product off the support member. Furthermore, example embodiments may allow consumers to eat the baked product without touching it with their fingers, when the baked product is dunked. Example methods may include inserting the support member (e.g., a dunking stick) into the baked product as part of the baking process. In various example embodiments, the support member material may consist of any material suitable for the baking process including but not limited to wood, plastic or metal. The positioning of the support member relative to the baked product assembly can vary based on shape and size of the baked product assembly. The depth to which the support member is inserted into the baked product can vary.

In accordance with yet another aspect, the size of the support member can vary in width, length and thickness. Additionally, the support member may not have a uniform shape.

In accordance with yet another aspect, the part of the support member (e.g., a blade portion) that is inserted into the baked product can vary in design and shape to allow for a better grip inside the baked product based on the texture and consistency of the baked product.

In accordance with yet another aspect, the support member may carry advertising.

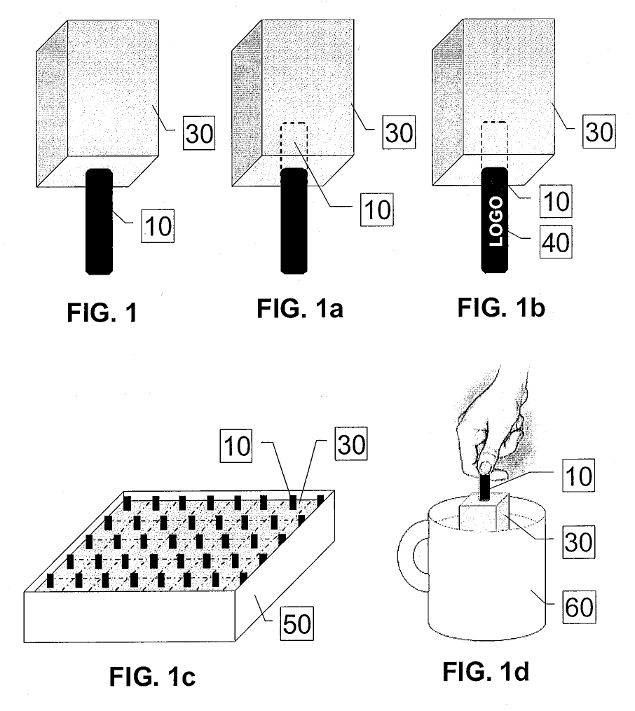

Referring now to FIG. 1, there is shown a perspective view of an embodiment of a support member, in the exemplary form of a dunking stick 10. The dunking stick 10 can be made from various materials including but not limited to ceramics, wood, plastic or metal. As will be described in further detail below, in one exemplary embodiment, the dunking stick 10 is inserted into the dough that forms the baked product 30 before or during the baking process. For the purposes of the current specification, the combination of the support member and baked product 30 (whether in a baked or pre-baked state) shall be referred to as a baked product assembly. It will be appreciated that the dunking stick 10 will be subject to a heated environment (typically within an oven) during the baking process. The dunking stick 10 is thus made from any material that is able to withstand being subject to heat sufficient to bake the baked product 30.

While certain types of plastic melt when subject to heat, in one example embodiment, the dunking stick 10 is made of a plastic that has a melting point higher than a temperature at which a baked product 30 is baked. The temperature at which a baked product 30 is baked typically ranges between 350 and 450 degrees Fahrenheit.

Turning now to FIG. 1a, there is shown a perspective view of the dunking stick 10 inserted into and extending from a baked product 30 (e.g., a cookie or biscuit).

Turning now to FIG. 1b, a logo 40 is shown to be placed on the surface of the dunking stick 10, and may comprise any shape, logo, brand, or picture desired.

Turning now to FIG. 1c, there is shown a perspective view of baked products in the exemplary form of cookies or biscuits still in the baking pan 50 with dunking sticks 10 extending from the individual cookies or biscuits 30 by between one and five inches.

Referring to FIG. 1d, the baked product assembly (e.g., a cookie or biscuit 30 with dunking stick 10) is used to dunk a cookie or biscuit 30 into cup of liquid 60 (e.g., coffee).

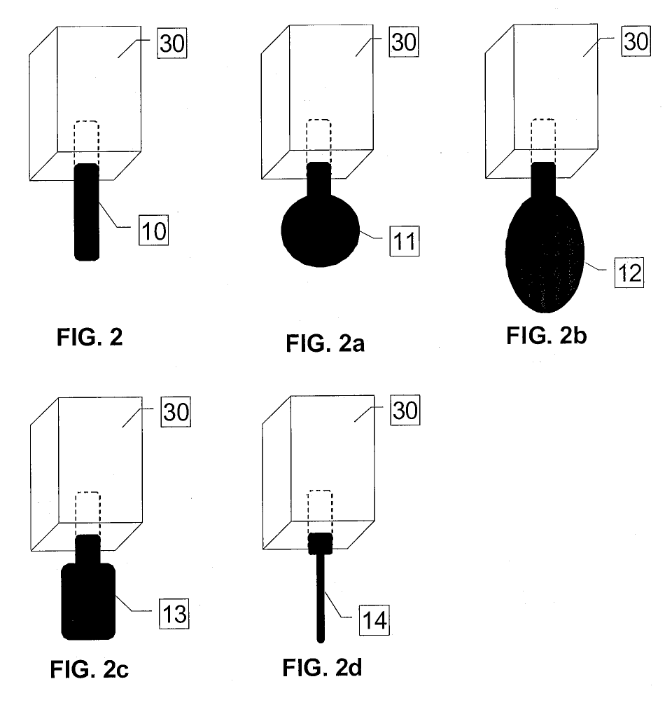

Turning now to FIG. 2, FIG. 2a, FIG. 2b, FIG. 2c and FIG. 2d, other embodiments of dunking sticks 10 are shown. These embodiments of dunking sticks 10 have different handle shapes 11/12/13/14 for ergonomic considerations including but not limited to the grip, touch and feel when holding the dunking stick 10. The ergonomic considerations are influenced by the weight and size of the baked product 30. In addition to the ergonomic considerations, the shape and size (11/12/13/14) of the dunking stick can also be influenced by the branding and marketing of the baked product.

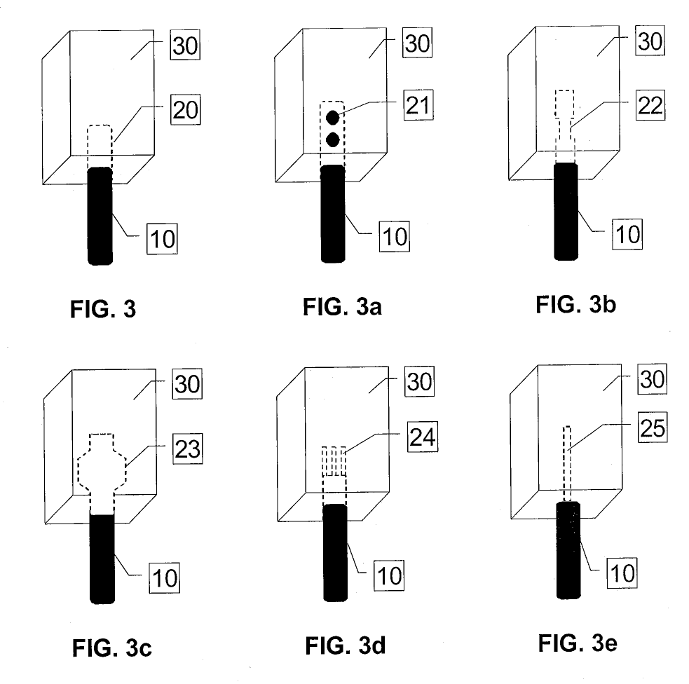

Turning now to FIG. 3, a further exemplary embodiment of a dunking stick 10 is shown. This embodiment of a dunking stick 10 has a uniform and/or linear edge that extends 20 into the cookie or biscuit.

Turning now to FIG. 3a, another exemplary embodiment of a dunking stick 10 is shown. This embodiment of a dunking stick 10 has one or more holes 21 in the portion of the dunking stick (e.g., a blade section) that extends into the cookie or biscuit 30, to improve the grip inside the cookie or biscuit 30 based on the texture and consistency of the cookie or biscuit 30.

Turning now to FIG. 3b, another embodiment of a dunking stick 10 is shown to demonstrate that the dunking stick is not limited to having a uniform and/or linear edge. This embodiment of a dunking stick 10 has a narrowing 22 in the portion of the dunking stick that extends into the cookie or biscuit 30, to improve the grip inside the cookie or biscuit 30 based on the texture and consistency of the cookie or biscuit 30.

Turning now to FIG. 3c, yet another embodiment of a dunking stick 10 is shown to demonstrate that the dunking stick is not limited to a uniform and/or linear edge. This exemplary embodiment of a dunking stick 10 has a widening 23 in the portion of the dunking stick that extends into the cookie or biscuit 30, to improve the grip inside the cookie or biscuit 30 based on the texture and consistency of the cookie or biscuit 30.

Turning now to FIG. 3d, yet another embodiment of a dunking stick 10 is shown. This exemplary embodiment of a dunking stick 10 has a fork-like ending 24 in the portion of the dunking stick 10 that extends into the cookie or biscuit 30, to improve the grip inside the cookie or biscuit 30 based on the texture and consistency of the cookie or biscuit 30.

Turning now to FIG. 3e, yet another embodiment of a dunking stick 10 is shown. This embodiment of a dunking stick 10 has a narrowing or pin-like 25 in the portion of the dunking stick 10 that extends into the cookie or biscuit 30, to improve the release of the cookie or biscuit 30 when eaten.

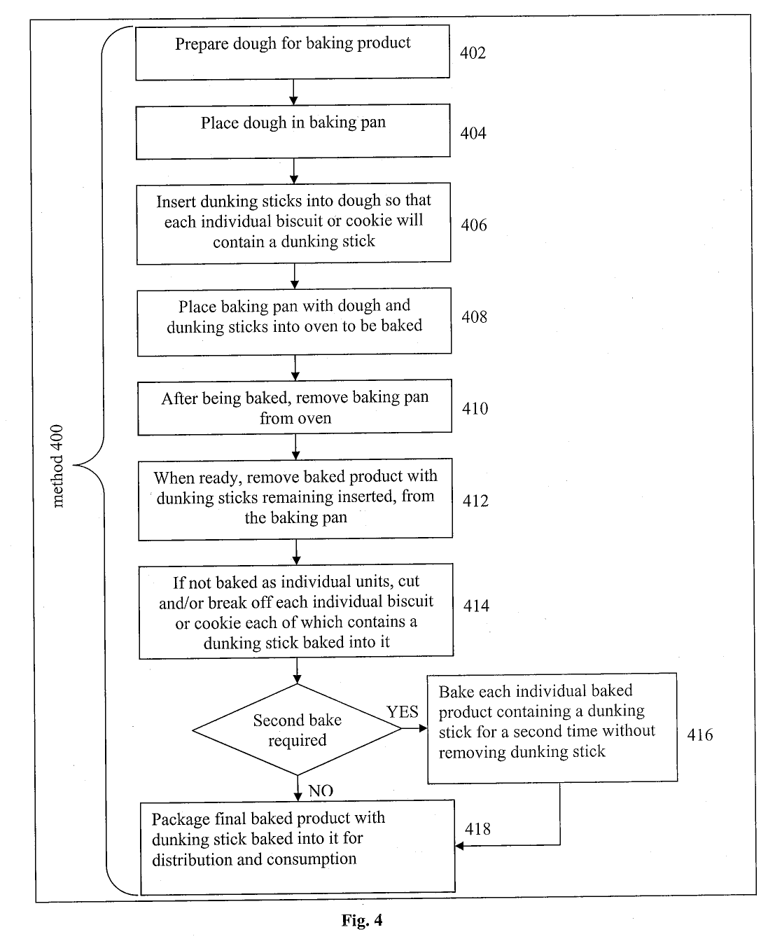

Turning to FIG. 4, a flowchart of a method 400 of manufacturing (baking) in accordance with exemplary embodiments.

First, the dough will be prepared (operation 402) in accordance to the recipe for the specific product being baked.

The dough that is ready for baking is then placed into the baking pan (operation 404). The baking pan can vary in shape and size. Some baking pans have separate compartments for each individual cookie or biscuit. Other baking pans may consist of one or more larger compartments that contain more than one individual cookie or biscuit.

After the dough is placed into the baking pan, a single support member (e.g., dunking stick 10) is placed into each individual cookie or biscuit (operation 406). When a baking pan is used that combines several individual cookies or biscuits into one, the dunking sticks 10 are placed into the dough so that once each individual cookie or biscuit is cut away, the cookie or biscuit will have a dedicated dunking stick 10. A baker may manually or automatically define lines into the dough to mark where each individual cookie or biscuit is to assist in correctly placing the dunking sticks into the dough.

The baking pan with dough and dunking sticks are then placed into an oven (operation 408), where it is baked for a time specified in a recipe.

After the required baking time, the baking pan is removed from the oven (operation 410) and left to cool down before removing the baked product assembly, with the dunking stick remaining inserted, from the baking pan (operation 412).

If not baked as individual cookies or biscuits, the baked product assembly is cut into each individual cookie or biscuit, each of which contains a dunking stick (operation 414).

Some baked product assemblies may require a second baking (e.g., drying) of the individual cookies or biscuits, with dunking sticks still remaining inserted (operation 416), in order to obtain cookies or biscuits that have a crisp texture.

The baking product assembly with a dunking stick baked into it is then packaged (operation 418) for distribution and consumption by consumers.

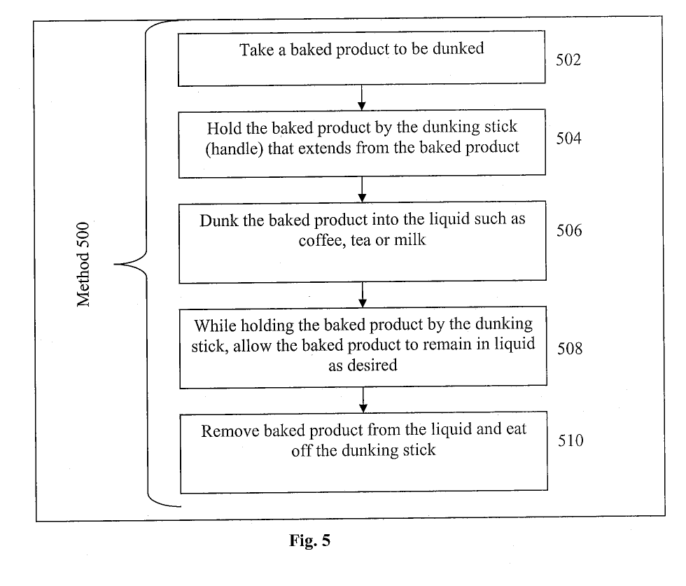

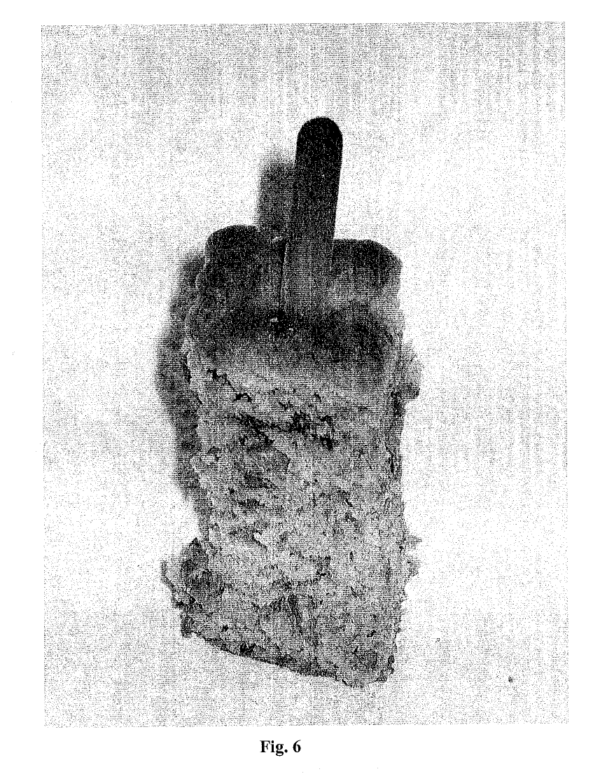

Turning to FIG. 5, a flowchart of a method 500 of a baked product dunking process in accordance with an exemplary embodiment.

The person desiring to dunk the baked product in a liquid (e.g., coffee, tea or milk) will take the baked product (operation 502) by holding it by a handle section of the dunking stick 10 (operation 504) that conveniently extends from the baked product. It should be noted that no separate device or apparatus is required.

Holding the baked product by the handle section of the dunking stick, the person will lower the baked product into the liquid (operation 506) for sufficient time (operation 508) to release the flavor in the baked product and to absorb the liquid. The absorption of the liquid by the baked product 30 may add more flavor and softens the texture of the baked product 30.

The person then removes the baked product assembly from the liquid, while still holding the baked product assembly by the handle section of the dunking stick 10, and eat the baked product 30 off the dunking stick 10 (operation 510).

Exemplary embodiments also provide for a method of manufacturing a support member for a baked product. The method includes defining a blade portion of the support member with a non-linear profile to be at least partially embedded within dough to be baked to create the baked product. A handle portion of the support member is defined with an ergonomic profile to be gripped between fingers of a user. Thus, examples of a baked product assembly, support member and associated methods of manufacturing have been described, which seek to provide a convenient manner by which any shape of cookie or biscuit can be dunked or at least partially immersed either into a liquid or simply enjoyed without having to touch the baked product with your finger.

1. A method of creating a baked product assembly, the method comprising:
providing a body of dough to be baked; and
inserting a support member into the body of dough prior or during baking of the body of dough, the inserting of the support member including embedding a first section of the support member within the body of dough such that a second section on the support member protrudes from the body of dough.

2. The method of claim 1, including baking the body of dough with the support member inserted therein.

3. The method of claim 2, including allowing the baked product assembly to cool for a predetermined period of time.

4. The method of claim 1, wherein the providing of the body of dough to be baked includes positioning the body of the dough within a baking tray.

5. The method of claim 1, including providing a plurality of bodies of dough to be baked, and inserting respective support members into the bodies of the dough prior or during baking of the bodies of dough.

6. A method of manufacturing a support member for a baked product, the method comprising:
defining a blade portion of the support member with a non-linear profile to be at least partially embedded within dough to be baked to create the baked product; and
defining a handle portion of the support member with an ergonomic profile to be gripped between fingers of a user.

7. A baked product assembly comprising:
a baked product of substantially uniform baked material; and
a support member partially embedded within the baked product so as to extend from the baked product.

8. The baked product assembly of claim 7, wherein the support member extends from the baked product by at least one centimeter.

9. The baked product assembly of claim 7, wherein the support member is constructed from at least one of a ceramic, plastic, metal or a wooden material.

10. The baked product assembly of claim 7, wherein the support member includes a first section to be embedded within the baked product and having a first form characteristic, and a second section to be gripped by a user and having a second form characteristic different from the first form characteristic.

11. The baked product assembly of claim 10, wherein the first form characteristic is at least one of a non-linear edge shape, or a cutout defined in the first section.

12. A support member for a baked product, the support member comprising:
a first portion, with a first shape, to be at least partially embedded within dough to be baked to create the baked product; and
a second portion, with a second shape, to be gripped between fingers of a user, the second shape being different from the first shape.

13. The support member of claim 12, wherein the first shape is at least one of a non-linear profile or a defining of a cutout with the first portion of the support member.

14. The support member of claim 12 wherein the second shape is an ergonomic shape.

15. A method of immersing a baked product, of substantially uniform contents, within a liquid, the method comprising:
gripping a handle portion of a support member, the handle portion of the support member extending from the baked product and a blade portion of the support member being embedded with the substantially uniform contents; and
immersing at least a portion of the baked product in the liquid using the support member.
